(19) United States
(12) Patent Application Publication
(10) Pub. No.: US 2006/0152130 A1
(43) Pub. Date: Jul. 13, 2006

(54) Flat fluorescent lamp, backlight assembly and liquid crystal display device having the same

(75) Inventors: Hyoung-Joo Kim, Uiwang-si (KR); Sang-Yu Lee, Yongin-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/203,015

(22) Filed: Aug. 11, 2005

(30) Foreign Application Priority Data
Jan. 10, 2005 (KR) 2005-2220

(51) Int. Cl. H01J 65/00; H01J 11/00; H01J 63/04

(52) U.S. Cl. 313/234; 313/607; 349/70

(57) ABSTRACT

A flat fluorescent lamp includes a lamp body having a plurality of discharge spaces, an external electrode that is formed at both ends of the lamp body and intersects the discharge spaces, and an auxiliary electrode coupled to the lamp body and electrically connected to the external electrode. The external electrode includes a main electrode portion intersecting the discharge spaces and a first compensation electrode portion extending from the main electrode portion such that the first compensation electrode portion is formed at the outermost discharge spaces of the discharge spaces. The auxiliary electrode is formed at the outermost discharge spaces where the first compensation electrode portion is formed. Thus, a pin-hole defect of the flat fluorescent lamp may be prevented.

### CROSS-REFERENCE TO RELATED APPLICATIONS

This application claims priority of Korean Patent Application No. 2005-2220 filed on Jan. 10, 2005, the contents of which are herein incorporated by reference in its entirety.

### BACKGROUND OF THE INVENTION

1. Field of the Invention

The present invention relates to a flat fluorescent lamp, a backlight assembly and a liquid crystal display apparatus. More particularly, the present invention relates to a flat fluorescent lamp capable of preventing a pin-hole defect, a backlight assembly and a liquid crystal display apparatus having the flat fluorescent lamp.

2. Description of the Related Art

In general, a liquid crystal display apparatus displays an image using the optical and electrical properties of liquid crystals, such as their anisotropic refractive index and their anisotropic dielectric constant. The liquid crystal display apparatus is lighter weight, lower power consumption and lower driving voltage than such display apparatus as a cathode ray tube or a plasma display panel.

The liquid crystal display apparatus requires a backlight assembly since its display panel is not self-emissive.

A tubular cold cathode fluorescent lamp is often used as the light source for a liquid crystal display apparatus. However, in a large-scaled liquid crystal display apparatus, both the number of the cold cathode fluorescent lamps required and the manufacturing cost increase, so that optical properties, such as brightness uniformity, deteriorate.

In recent years, to reduce the manufacturing cost and to enhance the brightness uniformity, a flat fluorescent lamp which emits a planar light has been developed. The flat fluorescent lamp includes a lamp body having a plurality of discharge spaces to uniformly emit a light and an external electrode that applies a discharge voltage to the lamp body. When the discharge voltage from an inverter is applied to the external electrode, a plasma discharge is generated in each of the discharge spaces. A fluorescent layer inside the flat fluorescent lamp is excited by ultraviolet light from the plasma discharge to generate a visible light.

When the flat fluorescent lamp is driven, the brightness in the outermost discharge spaces on both sides of the flat fluorescent lamp is lower than the brightness in other discharge spaces due to a difference in a parasitic capacitance between a metal receiving container and the flat fluorescent lamp. Thus, to compensate for this brightness difference, the flat fluorescent lamp includes a compensation electrode formed in the outermost discharge spaces. However, since a current flowing through the discharge spaces is concentrated in the discharge spaces in which the compensation electrode is formed, a pin-hole defect which partically punctures the lamp body occurs.

### SUMMARY OF THE INVENTION

The present invention provides a flat fluorescent lamp capable of preventing a pin-hole defect.

The present invention also provides a backlight assembly having the above flat fluorescent lamp.

The present invention also provides a liquid crystal display apparatus having the above backlight assembly.

In one aspect of the present invention, a flat fluorescent lamp includes a lamp body, an external electrode and an auxiliary electrode. The lamp body has a plurality of discharge spaces to emit light. The external electrode is formed at both ends of the lamp body and intersects the discharge spaces. The auxiliary electrode is coupled to the lamp body and electrically connected to the external electrode. The external electrode has a main electrode portion intersecting the discharge spaces and a first compensation electrode portion extended from the main electrode portion, such that the first compensation electrode portion is formed overlapping the outermost discharge spaces. The auxiliary electrode is formed adjacent the outermost discharge spaces where the first compensation electrode portion is formed.

In another aspect of the present invention, a backlight assembly includes a receiving container, a flat fluorescent lamp, a first mold and an inverter. The receiving container has a receiving space into which the flat fluorescent lamp is received. The flat fluorescent lamp has a lamp body divided into a plurality of discharge spaces and an external electrode that is formed at both ends of the lamp body and intersects the discharge spaces. The first mold fixes the flat fluorescent lamp to the receiving container and covers the external electrode. The first mold has an auxiliary electrode electrically connected to the external electrode. The inverter generates a discharge voltage for the flat fluorescent lamp. The external electrode includes a main electrode portion that intersects the discharge spaces and a first compensation electrode portion extended from the main electrode portion, such that the first compensation electrode portion is formed overlapping the outermost discharge spaces. The auxiliary electrode is formed adjacent the outermost discharge spaces where the first compensation electrode portion is formed.

In still another aspect of the present invention, a liquid crystal display apparatus includes a receiving container having a receiving space, a flat fluorescent lamp, an inverter and a liquid crystal display panel. The flat fluorescent lamp has a lamp body divided into a plurality of discharge spaces to generate light, an external electrode that is formed at both ends of the lamp body and intersects the discharge spaces, and an auxiliary electrode coupled to the lamp body and electrically connected to the external electrode. The inverter generates a discharge voltage for the flat fluorescent lamp. The liquid crystal display panel displays an image using light from the flat fluorescent lamp.

In further still another aspect of the present invention, a liquid crystal display apparatus includes a receiving container having a receiving space, a flat fluorescent lamp, a first mold, an inverter and a liquid crystal display panel. The flat fluorescent lamp has a lamp body divided into a plurality of discharge spaces to generate light and an external electrode that is formed at both ends of the lamp body and intersects the discharge spaces. The first mold fixes the flat fluorescent lamp to the receiving container and covers the external electrode. The first mold has an auxiliary electrode electrically connected to the external electrode. The inverter generates a discharge voltage for the flat fluorescent lamp. The liquid crystal display panel displays an image using the light from the flat fluorescent lamp.

According to the above, the pin-hole defect of the lamp body may be prevented, thereby improving reliability of the lamp body.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing a flat fluorescent lamp according to an exemplary embodiment of the present invention;

FIG. 2 is a plan view of the flat fluorescent lamp in FIG. 1;

FIG. 3 is a cross-sectional view taken along a line I-I′ showing the flat fluorescent lamp in FIG. 1;

FIG. 4 is a partially enlarged view showing the flat fluorescent lamp in FIG. 2;

FIG. 5 is a perspective view showing an auxiliary electrode in FIG. 1;

FIG. 6 is a plan view showing a flat fluorescent lamp according to another exemplary embodiment of the present invention;

FIG. 7 is an exploded perspective view showing a backlight assembly according to an exemplary embodiment of the present invention;

FIG. 8 is a cross-sectional view taken along a line II-II′ showing a first mold in FIG. 7; and

FIG. 9 is an exploded perspective view showing a liquid crystal display apparatus according to an exemplary embodiment of the present invention.

### DESCRIPTION OF THE EMBODIMENTS

Hereinafter, the present invention will be explained in detail with reference to the accompanying drawings.

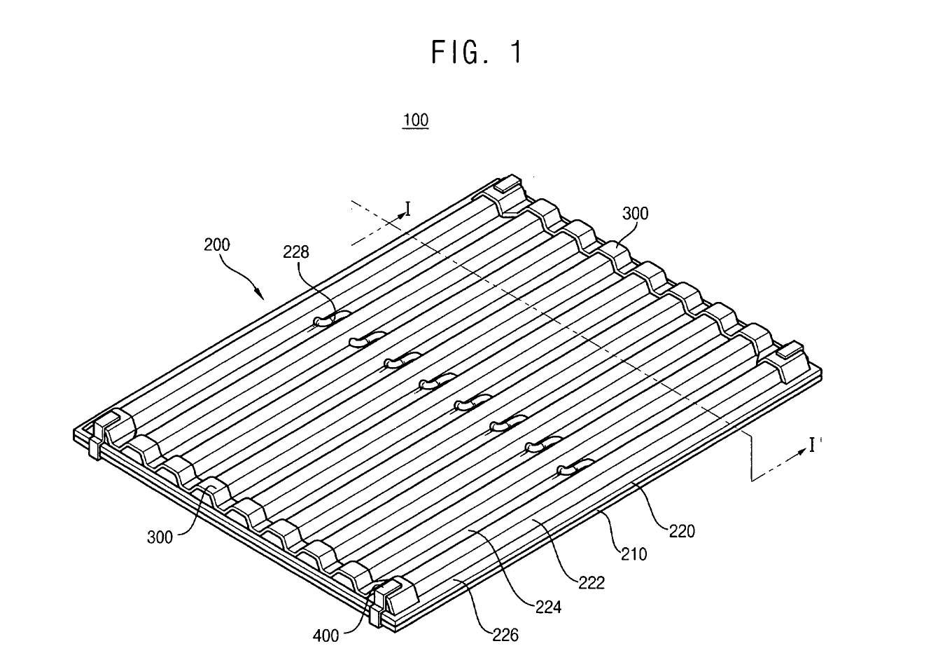

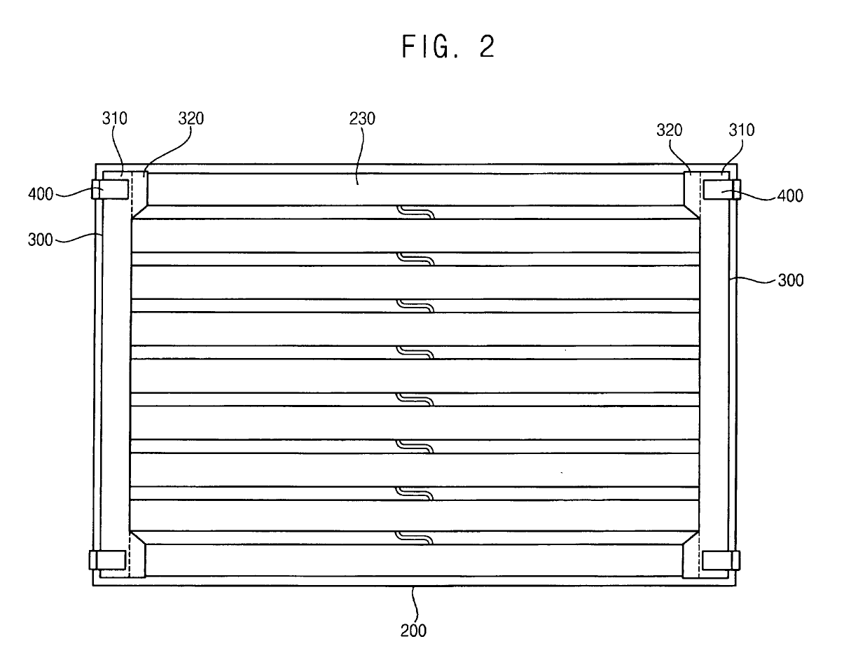

FIG. 1 is a perspective view showing a flat fluorescent lamp according to an exemplary embodiment of the present invention. FIG. 2 is a plan view of the flat fluorescent lamp in FIG. 1.

Referring to FIGS. 1 and 2, a flat fluorescent lamp 100 includes a lamp body 200, an external electrode 300 and an auxiliary electrode 400.

The lamp body 200 is divided into a plurality of discharge spaces 230 to emit light. In order to emit a planar light, the lamp body 200 is substantially rectangular in a plan view. The lamp body 200 makes a plasma discharge in the discharge spaces 230 in response to a discharge voltage applied from an inverter. The lamp body 200 converts ultraviolet lights generated in the plasma discharge into visible lights and emits the visible lights. The lamp body 200 has an inner space divided into the discharge spaces 230, which improve light emitting efficiency and light uniformity. The lamp body 200 includes a first substrate 210 and a second substrate 220 coupled to the first substrate 210 to form the discharge spaces 230.

The external electrode 300 is formed at both ends of the lamp body 200, such that the external electrode 300 intersects the discharge spaces 230. The external electrode 300 is formed on an outer face of the second substrate 220. The external electrode 300 may be formed on an upper face and a lower face of the lamp body 200.

The external electrode 300 includes a main electrode portion 310 and a first compensation electrode portion 320. The main electrode portion 310 has a uniform width and intersects all discharge spaces 230 of the lamp body 200. The first compensation electrode portion 320 is extended from the main electrode portion 310 toward a center portion of the discharge spaces 230, such that the first compensation electrode portion 320 overlaps the uppermost and lowermost discharge spaces, as shown in FIG. 2. The first compensation electrode portion 320 compensates the brightness of the uppermost and lowermost discharge spaces 230. That is, when the flat fluorescent lamp 100 is received into the receiving container that comprises a metal, most discharge spaces 230 make contact with only a bottom of the receiving container, but the uppermost and lowermost discharge spaces 230 make contact with both the bottom and a side face of the receiving container, thereby increasing a parasitic capacitance between the uppermost and lowermost discharge spaces 230 and the receiving container. As a result, the brightness of the uppermost and lowermost discharge spaces 230 becomes lower than the other ones of discharge spaces 230. However, since the external electrode 300 has an enhanced area overlapping the uppermost and lowermost discharge spaces 230 due to the first compensation electrode portion 320, the first compensation electrode portion 320 may compensate the brightness of the uppermost and lowermost discharge spaces 230.

The auxiliary electrode 400 is coupled to the lamp body 200, so that the auxiliary electrode 400 is electrically connected to the external electrode 300. In particular, the auxiliary electrode 400 is coupled to the portions of the uppermost and lowermost discharge spaces 230 where the first compensation electrode portion 320 is formed. In the present embodiment, the auxiliary electrode 400 includes four pieces coupled to four ends of the uppermost and lowermost discharge spaces 230, respectively.

The auxiliary electrode 400 prevents the occurrence of a pin-hole at the discharge spaces 230 where the first compensation electrode 320 is located. That is, as a relatively large amount of current flows through the discharge spaces 230 at which the first compensation portion 320 overlaps, in comparison with the currents in other ones of the discharge spaces 230, the pin-hole defect, which would otherwise easily occur, is prevented. The auxiliary electrode 400 enhances the resistance in the part of the lamp body 200 where the first compensation portion 320 is formed against a dielectric breakdown and disperses the electric fields applied to the discharge spaces 230, thereby preventing the pin-hole defect.

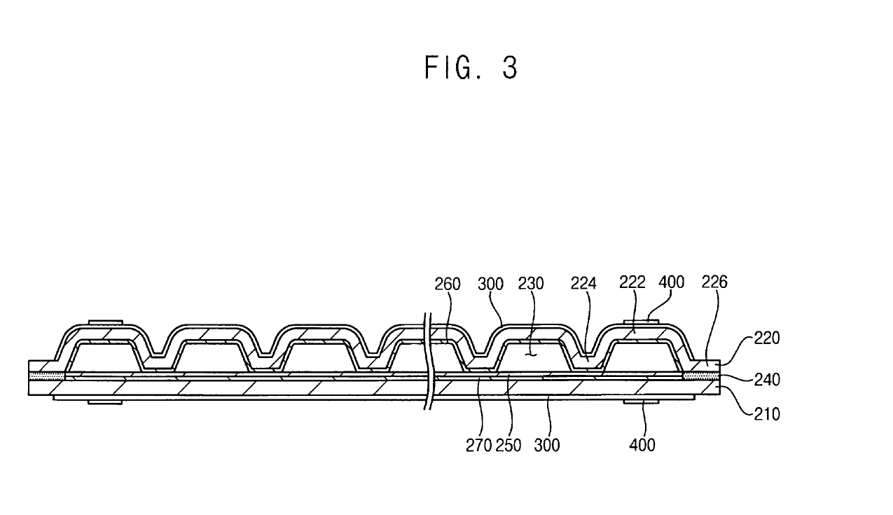

FIG. 3 is a cross-sectional view taken along a line I-I′ showing the flat fluorescent lamp in FIG. 1.

Referring to FIGS. 1 and 3, the flat fluorescent lamp 100 includes the lamp body 200, the external electrode 300 formed at both ends of the lamp body 200 and the auxiliary electrode 400 electrically connected to the external electrode 300.

The lamp body 200 includes the first and second substrates coupled to each other to form the discharge spaces 230.

The first substrate 210 has a substantially rectangular plate-like shape. The first substrate 210 includes a glass. The first substrate 210 may further include a blocking material which prevents the ultraviolet light generated in the discharge spaces 230 from leaking.

The second substrate 220 includes a transparent material such as a glass, so that the visible light generated in the discharge spaces 230 may transmit through the second substrate 220. The second substrate 220 also may further include a blocking material which prevents the ultraviolet light generated in the discharge spaces 230 from leaking.

The second substrate 220 includes discharge space portions 222 which form the discharge spaces, space-dividing portions 224 and a sealing portion 226. The discharge space portions 222 are spaced apart from the first substrate 210 to form the discharge spaces 230. The space-dividing portions 224 are disposed between the discharge space portions 222 and make contact with the first substrate 210 to divide the discharge spaces 230. The sealing portion 226 is formed at an end of the second substrate 220 and is coupled to the first substrate 210.

The second substrate 220 may be formed in a molding process. For example, the second substrate 220 may be formed by heating a glass substrate having a plate-like shape in a mold to a predetermined temperature, thereby forming the discharge space portions 222, the space-dividing portions 224 and the sealing portion 226. Alternatively, the second substrate 220 may be formed by heating the glass substrate and injecting an air into the heated glass substrate.

The second substrate 220 has a cross-sectional profile in which a plurality of half-arches is arranged one after another, as shown in FIG. 2. However, the second substrate 220 may have other cross-sectional profiles including, for example, a semicircle, a square, or a trapezoid.

The second substrate 220 has connection paths 228 connecting adjacent discharge spaces 230 to each other. Each of the discharge spaces 230 is connected to one or more adjacent discharge spaces 230 through one or more connection paths 228. A discharge gas injected into the discharge spaces 230 flows to other discharge spaces 230 through the connection paths 228, such that the discharge gas may be uniformly distributed into all discharge spaces 230.

The connection paths 228 are substantially and simultaneously formed through the molding process. The connection paths 228 may have various shapes such as an “S” shape. When the connection paths 228 each have an “S” shape, a channeling phenomena due to interference between the discharge spaces 230 may be prevented, since the path through which the discharge gas flows is lengthened.

The second substrate 220 is coupled to the first substrate 210 by an adhesive 240, such as a frit having a melting point lower than that of a glass. That is, the adhesive 240 is disposed between the first and second substrates 210 and 220 at the sealing portion 226, and then the adhesive 240 is heated to thereby combine the first substrate 210 with the second substrate 220. In the present embodiment, the adhesive 240 is only applied at the sealing portion 226 between the first and second substrates 210 and 220, and not at the space-dividing portions 224 where the second substrate 220 makes contact with the first substrate 210. The first and second substrate 210 and 220 combine at a temperature between about 400 degrees and about 600 degrees.

The space-dividing portions 224 adhere to the first substrate 210 due to a pressure difference between an inner space and an outer space of the lamp body 200. Particularly, when the first and second substrates 210 and 220 are coupled to each other and the air in the discharge spaces 230 is evacuated, the discharge spaces 230 of the lamp body 200 maintain inner spaces that are in a vacuum state. Various discharge gases are injected into the discharge spaces 230 to allow plasma discharges in the discharge spaces. In the present embodiment, examples of applicable discharge gas may include mercury (Hg), neon (Ne) and argon (Ar). In the present embodiment, a gas pressure in the discharge spaces 230 may range from about 50 Torr to about 70 Torr lower than the atmospheric pressure of about 760 Torr. Due to a pressure difference between the gas pressure in the discharge spaces 230 and the atmospheric pressure, a force is applied to the lamp body 200 toward the discharge spaces 230, so that the space-dividing portions 224 adhere to the first substrate 210.

The lamp body 200 further includes a first fluorescent layer 250 formed on the inner surface of the first substrate 210 and a second fluorescent layer 260 formed on the inner surface of the second substrate 220. The first and second fluorescent layers 250 and 260 are excited to emit visible light, in response to ultraviolet light that is generated by the plasma discharge in the discharge spaces 230.

The lamp body 200 further includes a reflecting layer 270 formed between the first substrate 210 and the first fluorescent layer 250. The reflecting layer 270 reflects visible light emitted from the first and second fluorescent layers 250 and 260, thereby preventing light from leaking through the first substrate 210. To enhance reflectance and to reduce variation in colors, the reflecting layer 270 includes a metal oxide material, such as aluminum oxide (Al₂O₃) or barium sulfate (BaSO₄).

The first fluorescent layer 250, the second fluorescent layer 260 and the reflecting layer 270 are sprayed onto the first and second substrates 210 and 220 before coupling the first substrate 210 to the second substrate 220. The first fluorescent layer 250, the second fluorescent layer 260 and the reflecting layer 270 are formed over the first and second substrates 210 and 220 except over the sealing portion 226. The first fluorescent layer 250, the second fluorescent layer 260 and the reflecting layer 270 are not formed at the space-dividing portions 224.

Although not shown in FIG. 3, the lamp body 200 may further include a passivation layer formed between the first substrate 210 and the reflecting layer 270 and/or between the second substrate 220 and the second fluorescent layer 260. The passivation layer blocks a chemical reaction between the first and second substrates 210 and 220 and the discharge gas (e.g., mercury (Hg)), thereby preventing mercury loss and blackening the lamp body 200.

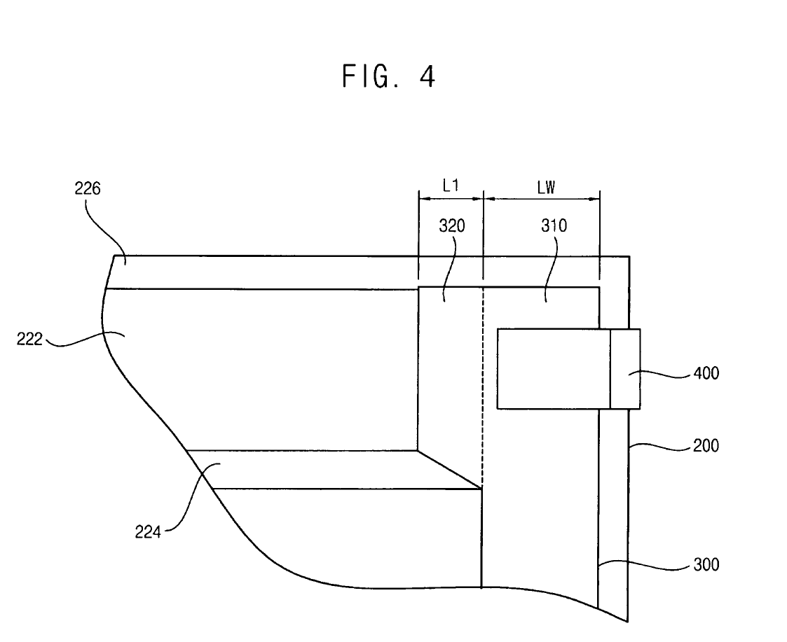

FIG. 4 is a partially enlarged view showing the flat fluorescent lamp in FIG. 2.

Referring to FIG. 4, the external electrode 300 includes the main electrode portion 310 that intersects the discharge spaces 230 and the first compensation electrode portion 320 that is extended from the main electrode portion 310.

The main electrode portion 310 is extended in a substantially perpendicular direction to a longitudinal direction of the discharge space portions 222. The main electrode portion 310 has a uniform line width LW of about 10 mm.

The first compensation electrode portion 320 is formed at the uppermost and lowermost discharge spaces 230. The first compensation electrode portion 320 is extended to the center portion of the uppermost and lowermost discharge spaces 230 by a first length L1 suitable to compensate the lowered brightness of the uppermost and lowermost discharge spaces 230. In the present embodiment, the first compensation electrode portion 320 has the first length L1 from about 2 mm to about 3 mm.

The external electrode 300 may include a conductive material to apply the discharge voltage from the inverter to the lamp body 200. The external electrode 300 is formed by coating a silver (Ag) paste having as ingredients silver (Ag) and silicon oxide (SiO₂). Alternatively, the external electrode 300 is formed by spraying a metal powder having at least one conductive material (e.g., a metal or a metal composition). Although not shown in figures, the lamp body 200 may further include an insulating layer formed on an outer face of the external electrode 300 to protect the external electrode 300.

In order to prevent the pin-hole defect, the auxiliary electrode 400 is coupled to the lamp body 200. That is, the auxiliary electrode 400 is formed at the uppermost and lowermost discharge spaces 230 where the first compensation electrode portion 320 is formed. The auxiliary electrode 400 is connected to the external electrode 300.

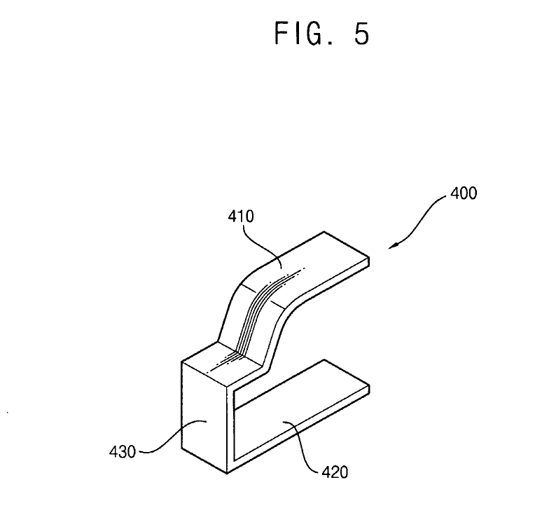

FIG. 5 is a perspective view showing the auxiliary electrode 400 of FIG. 1.

Referring to FIGS. 1 and 5, the auxiliary electrode 400 includes a conductive metal part to be electrically connected to the external electrode 300. The auxiliary electrode 400 is electrically connected to the external electrode 300 and covers the side portion of the lamp body 200. The auxiliary electrode 400 has a shape that conforms to the outer portion the lamp body 200, so that the auxiliary electrode 400 may be stably coupled to the lamp body 200.

The auxiliary electrode 400 includes a first contact portion 410 corresponding to an upper portion of the lamp body 200, a second contact portion 420 corresponding to a lower portion of the lamp body 200 and a connection portion 430 connecting the first and second contact portions 410 and 420. When the external electrode 300 is formed over the upper surface and the lower surface of the lamp body 200, the first contact portion 410 is electrically connected to the portion of the external electrode 300 formed over the upper face of the lamp body 200, and the second contact portion 420 is electrically connected to the portion of the external electrode 300 formed over the lower face of the lamp body 200.

In order to stably couple the auxiliary electrode 400 to the lamp body 200, the first and second contact portions 410 and 420 may be soldered to the external electrode 300. Each of the first and second contact portions 410 and 420 includes at least one hole to improve reliability of the soldering process. Alternatively, the auxiliary electrode 400 may be electrically connected to the external electrode using a conductive material, such as an anisotropic conductive film (ACF) or a silver paste.

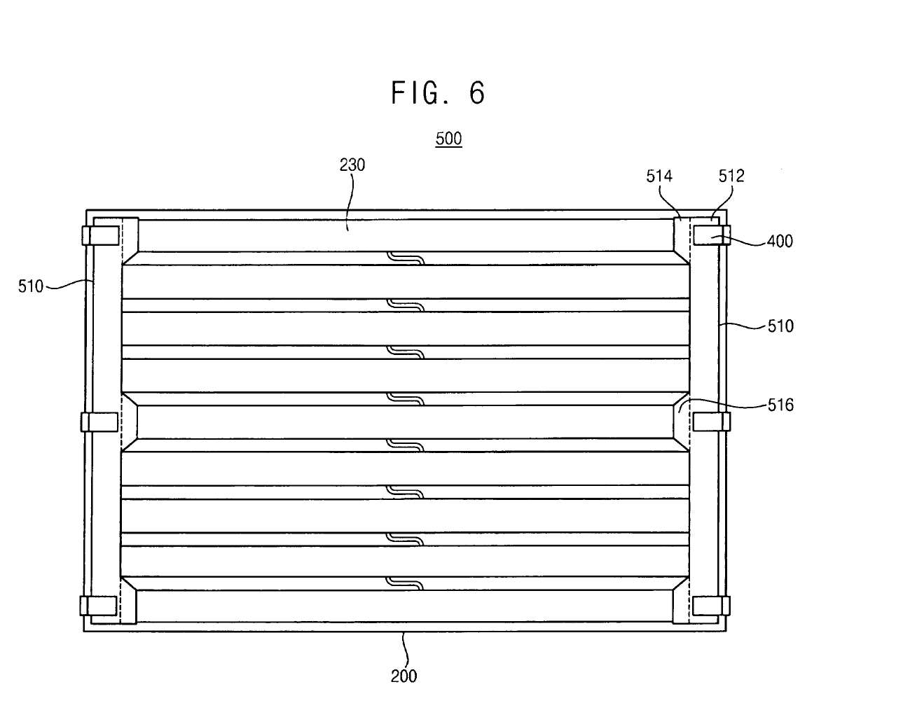

FIG. 6 is a plan view showing a flat fluorescent lamp according to another exemplary embodiment of the present invention.

Referring to FIG. 6, a flat fluorescent lamp 500 includes a lamp body 200, an external electrode 510 and an auxiliary electrode 400. In FIG. 6, the same reference numerals denote the same elements in FIG. 1, and thus any further detailed descriptions of the same elements will be omitted.

The external electrode 510 is formed on both ends of the lamp body 200 such that the external electrode 510 intersects the discharge spaces 230. In the present embodiment, the external electrode 510 is formed on an upper outer surface of the lamp body 200. In fact, the external electrode 510 may be formed on the upper outer surface and the lower outer surface of the lamp body 200.

The external electrode 510 includes a main electrode portion 512 that intersects the discharge spaces 230, a first compensation electrode portion 514 that extends from the main electrode portion 512 and a second compensation electrode portion 516 that also extends from the main electrode portion 512.

The main electrode portion 512 extends in a substantially perpendicular direction to the longitudinal direction of the discharge space 230. The main electrode portion 512 has a uniform line width LW of about 10 mm.

The first compensation electrode portion 514 is formed at the uppermost and lowermost discharge spaces 230. The first compensation electrode portion 514 extends to the center portion of the uppermost and lowermost discharge spaces 230 by a first length L1 suitable to compensate the lowered brightness of the uppermost and lowermost discharge spaces 230. In the present embodiment, the first compensation electrode portion 514 has the first length L1 from about 2 mm to about 3 mm.

The second compensation electrode portion 516 is formed at a center discharge space of the discharge spaces 230. The second compensation electrode portion 516 extends from both ends of the center discharge space to the center portion of the discharge spaces 230, to enhance the brightness at the center portion. In the present embodiment, the second compensation electrode portion 516 extends over a range from about 1 mm to about 2 mm. Although the second compensation electrode portion 516 is shown to be formed only on a center discharge space, the second compensation electrode portion 516 may in fact be formed on several discharge spaces at the center portion of the lamp body 200.

In order to prevent the pin-hole defect, the auxiliary electrode 400 is coupled to the lamp body 200. Particularly, the auxiliary electrode 400 is formed at both ends of the uppermost, lowermost and center discharge spaces 230 over which the first compensation electrode portion 514 and the second compensation electrode portion 516 are formed. Thus, six auxiliary electrode portions are coupled to the lamp body 200, thereby electrically connecting the auxiliary electrode 400 to the external electrode 510.

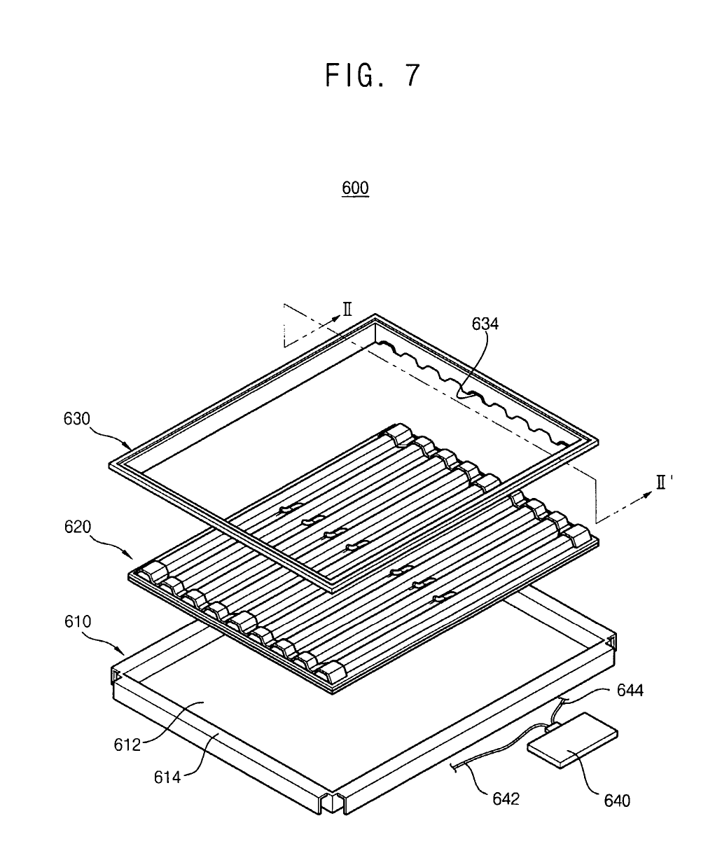

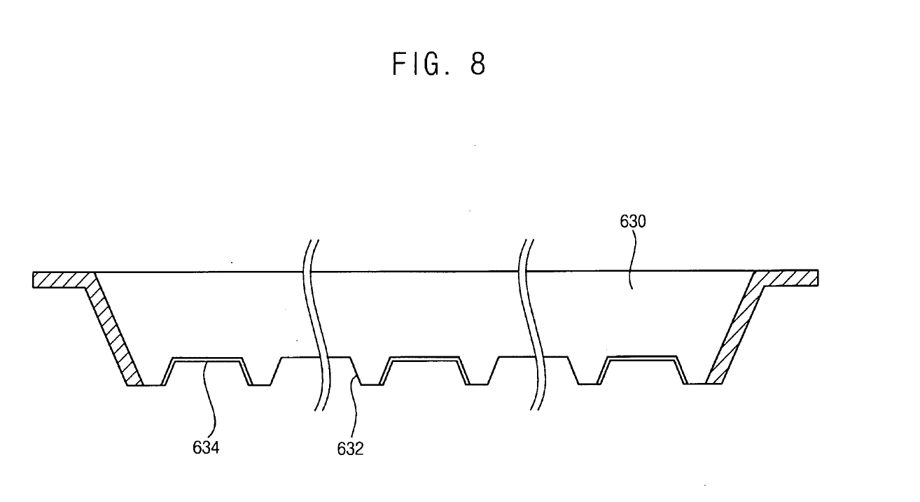

FIG. 7 is an exploded perspective view showing a backlight assembly according to an exemplary embodiment of the present invention. FIG. 8 is a cross-sectional view taken along a line II-Il′ showing a first mold in FIG. 7.

Referring to FIGS. 7 and 8, a backlight assembly includes a receiving container 610, a flat fluorescent lamp 620, a first mold 630 and an inverter 640.

The receiving container 610 includes a bottom portion 612 and a side portion 614 extending from the bottom portion 612 to provide a receiving space for the flat fluorescent lamp 620. The side portion 614 is bent over two times in order to provide coupling space and coupling strength for various elements of a liquid crystal display apparatus (not shown). The receiving container 610 includes a metallic material having a superior strength to avoid deformation.

The flat fluorescent lamp 620 includes a lamp body 200 and an external electrode 510. In the present embodiment, the lamp body 200 and the external electrode 510 have same structure and function as those of the lamp body and the external electrode in FIG. 6, and thus any further detailed description thereof will be omitted.

The first mold 630 is coupled to the receiving container 610 to fix the flat fluorescent lamp 620 to the receiving container 610. The first mold 630 fixes an end of the flat fluorescent lamp 620 such that an end portion of the external electrode 510 is not exposed, and light is not emitted from that end portion. The first mold 630 includes recesses 632 conforming to the upper surfaces of the flat fluorescent lamp 620. That is, the recesses 632 follows the contours of the discharge space portions 622, respectively, protruded from the flat fluorescent lamp 620 to form the discharge spaces 230.

In the present embodiment, in order to prevent the pin-hole defect of the flat fluorescent lamp 620, the first mold 630 includes an auxiliary electrode 634 electrically connected to the external electrode 510. The auxiliary electrode 634 is formed inside the recesses 632. Particularly, the auxiliary electrode 634 is formed inside recesses 632 at the uppermost and lowermost discharge spaces 230 where the first compensation electrode portion 514 is formed. Also, when the second compensation electrode portion 516 is further formed on the flat fluorescent lamp 620, the auxiliary electrode 634 may be further formed inside recesses 632 at the center discharge spaces 230 where the first compensation electrode portion 514 is formed. Where the second compensation electrode portion 516 is not formed on the flat fluorescent lamp 620, the auxiliary electrode 634 need not be present in the flat fluorescent lamp 620.

As shown in FIG. 7, the first mold 630 is formed into a frame. However, the first mold 630 may also include two pieces forming a substantially U shape, or four pieces corresponding to four sides of the flat fluorescent lamp 620, respectively.

The inverter 640 generates the discharge voltage for the flat fluorescent lamp 620. The inverter 640 boosts an alternating current voltage at a low voltage level to output an alternating current voltage at a high voltage level as the discharge voltage. The discharge voltage generated from the inverter 640 is applied to the external electrode 510 of the flat fluorescent lamp 620 through a first power line 642 and a second power line 644.

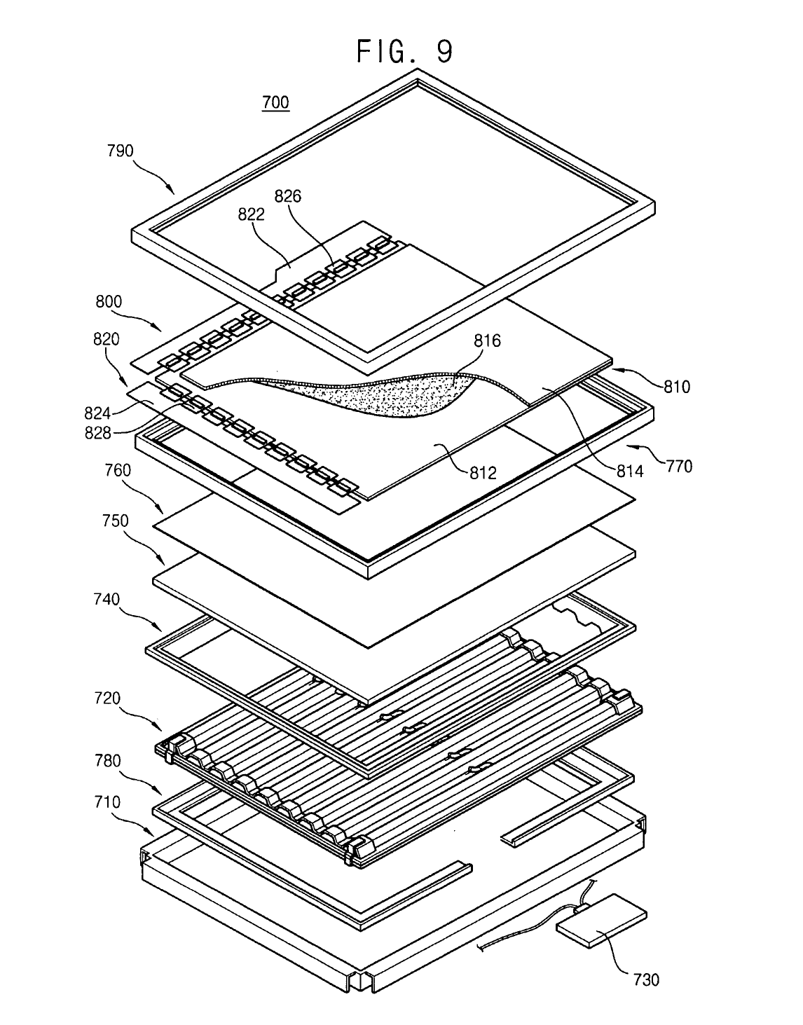

FIG. 9 is an exploded perspective view showing a liquid crystal display apparatus according to an exemplary embodiment of the present invention.

Referring to FIG. 9, a liquid crystal display apparatus 700 includes a receiving container 710, a flat fluorescent lamp 720, an inverter 730 and a display unit 800.

The receiving container 710 provides a receiving space into which the flat fluorescent lamp 720 is received. In the present embodiment, the receiving container 710 has same structure and functions as those of the receiving container 630 in FIG. 7, and thus any further detailed description of the receiving container 710 will be omitted.

The flat fluorescent lamp 720 includes a lamp body divided into a plurality of discharge spaces to emit light, an external electrode formed at both ends of the lamp body such that the external electrode intersects the discharge spaces and an auxiliary electrode coupled to the lamp body and electrically connected to the external electrode. The external electrode includes a main electrode portion that intersects the discharge spaces and a first compensation electrode portion that is extended from the main electrode portion and formed on uppermost and lowermost discharge spaces. The auxiliary electrode is formed at the discharge spaces on the first compensation electrode portion. The external electrode may further include a second compensation electrode portion formed on a center discharge space of the discharge spaces. The auxiliary electrode is further formed on the center discharge space on which the second compensation electrode portion is formed. In the present embodiment, the flat fluorescent lamp 720 has the same structure and functions as those of the flat fluorescent lamps shown in FIGS. 1 to 6, and thus any further detailed description of the flat fluorescent lamp 720 will be omitted.

The inverter 730 generates a discharge voltage for the flat fluorescent lamp 720. In the present embodiment, the inverter 730 has the same structure and functions as those of the inverter shown in FIG. 7, and thus any further detailed description of the inverter 730 will be omitted.

The display unit 800 includes a liquid crystal display panel 810 that displays an image using a light from the flat fluorescent lamp 720 and a driving circuit 820 that drives the liquid crystal display panel 810.

The liquid crystal display panel 810 includes a first substrate 812, a second substrate 814 facing the first substrate 812 and a liquid crystal layer 816 disposed between the first and second substrates 812 and 814.

The first substrate 812 is a TFT substrate on which TFTs are formed in a matrix configuration. The first substrate 812 includes a glass. Each of the TFTs has a source connected to a data line, a gate connected to a gate line and a drain connected to a pixel electrode that is a transparent and conductive material.

The second substrate 814 is a color filter substrate on which RGB pixels are formed by a thin film process. The second substrate 814 also includes the glass. The second substrate 814 includes a common electrode formed thereon. The common electrode includes a transparent conductive material.

When a power is applied to the gate of the TFT and the TFT is turned on, an electric field is generated between the pixel electrode and the common electrode. The electric field varies an aligning angle of the liquid crystal molecules interposed between the first substrate 812 and the second substrate 814. Thus, a light transmittance of the liquid crystal layer 816 is varied in accordance with the variation of the aligning angle of the liquid crystal, so a desired image may be obtained.

The driving circuit 820 includes a data printed circuit board 822 that applies a data driving signal to the liquid crystal display panel 810, a gate printed circuit board 824 that applies a gate driving signal to the liquid crystal display panel 810, a data flexible printed circuit film 826 that electrically connects the data printed circuit board 822 to the liquid crystal display panel 810 and a gate flexible printed circuit film 828 that electrically connects the gate printed circuit board 824 to the liquid crystal display panel 810. The data and gate flexible printed circuit films 826 and 828 include a tape carrier package (TCP) or a chip-on-film (COF).

The data and gate printed circuit boards 822 and 824 may be disposed on a side face or a rear face of the receiving container 710 by bending the data and gate flexible printed circuit films 826 and 828, respectively. In case that separated signal lines are formed on the liquid crystal display panel 710 and the gate flexible printed circuit film 728, the gate printed circuit board 724 may be removed.

The liquid crystal display apparatus 700 further includes a first mold 740 disposed between the flat fluorescent lamp 720 and a diffusion plate 750. The first mold 740 is coupled to the receiving container 710 to fix the flat fluorescent lamp 720 to the receiving container 710. The first mold 740 fixes an end of the flat fluorescent lamp 720 such that an end portion of the external electrode 510 is covered and light is not emitted from that end portion. The end portion supports an end of the diffusion plate 750. In the present embodiment, the first mold 740 is formed into a frame. Alternatively, the first mold 740 may include two pieces having a substantially U shape, or in four pieces corresponding to four sides of the flat fluorescent lamp 620, respectively.

If the flat fluorescent lamp 720 does not include an auxiliary electrode, the first mold 740 may further include the auxiliary electrode electrically connected to the external electrode corresponding to the discharge spaces on which the first and second compensation electrode portions are formed, as shown in FIG. 8.

The liquid crystal display apparatus 700 further includes the diffusion plate 750, an optical sheet 760 and a second mold 770.

The diffusion plate 750 is disposed on the flat fluorescent lamp 720. The diffusion plate 750 diffuses the lights from the flat fluorescent lamp 720 to improve the brightness uniformity of the lights. The diffusion plate 750 includes a transparent material such as polymethyl methacrylate (PMMA). Also, the diffusion plate 750 may further include a light diffusing agent for the lights.

The optical sheet 760 is disposed on the diffusion plate 750. The optical sheet 760 may be one or more sheets each formed from one of a number of materials, such as a prism sheet or a diffusion sheet. The prism sheet condenses the diffused light by the diffusion plate 750 to enhance brightness at a front view, and the diffusion sheet diffuses again the diffused light by the diffusion plate 750. Further, the liquid crystal display apparatus 700 may further include separate optical sheets thereto in accordance with required brightness characteristics.

The second mold 770 is disposed between the optical sheet 760 and the liquid crystal display panel 810. The second mold 770 fixes ends of the optical sheet 760 and the diffusion plate 750 and supports the end of the liquid crystal display panel 810. The second mold 770 also may be formed into a frame, two pieces or four pieces, as in the first mold 740.

The liquid crystal display apparatus 700 may further include a buffer member 780 disposed between the receiving container 710 and the flat fluorescent lamp 720 to support the flat fluorescent lamp 720. The buffer member 780 is disposed on the end of the flat fluorescent lamp 720. The buffer member 780 spaces the flat fluorescent lamp 720 apart from the receiving container 710 by a predetermined distance such that the flat fluorescent lamp 720 is not electrically connected to the receiving container 710. In order to electrically insulate the flat fluorescent lamp 720 from the receiving container 710, the buffer member 780 includes an insulating material. Also, the buffer member 780 may include an elastic material, such as silicone to absorb an impact externally applied to the flat fluorescent lamp 720. In the present embodiment, the buffer member 780 includes two pieces having a substantially U-shape. However, the buffer member 780 may include four pieces corresponding to sides or corners of the flat fluorescent lamp 720, respectively. The four pieces of the buffer member 780 may be integrally formed into one piece.

The liquid crystal display apparatus 700 may further include a top chassis 790 to fix the display unit 800. The top chassis 790 is coupled to the receiving container 710 to fix the end of the liquid crystal display panel 810 to the receiving container 710. The data printed circuit board 822 is bent by the data flexible printed circuit film 826, such that the data printed circuit board 822 is fixed to the side portion or the rear portion of the receiving container 710. The top chassis 790 is made of a material that includes a metal having a superior strength.

The separated auxiliary electrode is coupled to the lamp body, and electrically connected to the external electrode at the discharge spaces where the compensation electrode portion is provided, thereby preventing the pin-hole defect of the lamp body.

Furthermore, since the first mold includes the auxiliary electrode at the discharge spaces where the compensation electrode portion is provided, the pin-hole defect may be prevented.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A flat fluorescent lamp comprising:
a lamp body having a plurality of discharge spaces to emit light;
an external electrode being formed at both ends of the lamp body and intersecting the discharge spaces; and
an auxiliary electrode being coupled to the lamp body and electrically connected to the external electrode.

2. The flat fluorescent lamp of claim 1, wherein the external electrode comprises:
a main electrode portion intersecting the discharge spaces; and
a first compensation electrode portion extending from the main electrode portion at a position adjacent an outermost discharge space of the discharge spaces.

3. The flat fluorescent lamp of claim 2, wherein the auxiliary electrode is formed at a discharge space where the first compensation electrode portion is formed.

4. The flat fluorescent lamp of claim 3, wherein the external electrode further comprises a second compensation electrode portion extending from the main electrode portion at a center discharge space among the discharge spaces.

5. The flat fluorescent lamp of claim 4, wherein the auxiliary electrode is formed at the discharge spaces where the first and second compensation electrodes are formed.

6. The flat fluorescent lamp of claim 1, wherein the auxiliary electrode comprises:
a first contact portion corresponding to an upper portion of the lamp body;
a second contact portion corresponding to a lower portion of the lamp body; and
a connection portion to connect the first contact portion and the second contact portion.

7. The flat fluorescent lamp of claim 1, wherein the lamp body comprises:
a first substrate; and
a second substrate coupled to the first substrate to form the discharge spaces.

8. The flat fluorescent lamp of claim 7, wherein the second substrate comprises:
discharge space portions spaced a part from the first substrate to form the discharge spaces;
space-dividing portions coupled to the first substrate to divide the discharge spaces, the space-dividing portions being disposed between the discharge space portions; and
sealing portions formed on ends of the discharge space portions and the space-dividing portions and coupled to the first substrate.

9. The flat fluorescent lamp of claim 7, wherein the external electrode is formed on an outer surface of the second substrate.

10. The flat fluorescent lamp of claim 7, wherein the external electrode is formed on outer surfaces of the first and second substrates.

11. A backlight assembly comprising:
a receiving container having a receiving space;
a flat fluorescent lamp having a lamp body divided into a plurality of discharge spaces and an external electrode that is formed at one or both ends of the lamp body and intersecting the discharge spaces, the flat fluorescent lamp being received into the receiving space;
a first mold to fix the flat fluorescent lamp to the receiving container and to cover the external electrode, the first mold having an auxiliary electrode electrically connected to the external electrode; and
an inverter to generate a discharge voltage for the flat fluorescent lamp.

12. The backlight assembly of claim 11, wherein the external electrode comprises:
a main electrode portion intersecting the discharge spaces; and
a first compensation electrode portion extending from the main electrode portion at the outermost discharge spaces among the discharge spaces.

13. The backlight assembly of claim 12, wherein the auxiliary electrode is formed at the outermost discharge spaces where the first compensation electrode portion is formed.

14. The backlight assembly of claim 12, wherein the external electrode further comprises a second compensation electrode portion extending from the main electrode portion at a center discharge space among the discharge spaces.

15. The backlight assembly of claim 14, wherein the auxiliary electrode is formed at the discharge spaces where the first and second compensation electrodes are formed.

16. The backlight assembly of claim 11, wherein the lamp body comprises:
a first substrate; and
a second substrate coupled to the first substrate to form the discharge spaces,
and wherein the second substrate comprises:
discharge space portions spaced apart from the first substrate to form the discharge spaces;
space-dividing portions coupled to the first substrate to divide the discharge spaces, the space-dividing portions being disposed between the discharge space portions; and
sealing portions formed on ends of the discharge space portions and the space-dividing portions and coupled to the first substrate.

17. The backlight assembly of claim 16, wherein the first mold comprises recesses conforming to the contours of the discharge space portions, and wherein the auxiliary electrode is formed inside the recesses.

18. A liquid crystal display apparatus comprising:
a receiving container having a receiving space;
a flat fluorescent lamp having a lamp body divided into a plurality of discharge spaces to generate light, an external electrode that is formed at both ends of the lamp body and intersects the discharge spaces, and an auxiliary electrode coupled to the lamp body and electrically connected to the external electrode;
an inverter to generate a discharge voltage for the flat fluorescent lamp; and
a liquid crystal display panel to display an image using the light from the flat fluorescent lamp.

19. The liquid crystal display apparatus of claim 18, wherein the external electrode comprises:
a main electrode portion intersecting the discharge spaces; and
a first compensation electrode portion extending from the main electrode portion at outermost discharge spaces among the discharge spaces.

20. The liquid crystal display apparatus of claim 19, wherein the auxiliary electrode is formed at the outermost discharge spaces where the first compensation electrode portion is formed.

21. The liquid crystal display apparatus of claim 19, wherein the external electrode further comprises a second compensation electrode portion extending from the main electrode portion at a center discharge space among the discharge spaces.

22. The liquid crystal display apparatus of claim 20, wherein the auxiliary electrode is formed at the discharge spaces where the first and second compensation electrodes are formed.

23. The liquid crystal display apparatus of claim 18, further comprising:
a first mold to fix the flat fluorescent lamp to the receiving container and to cover the external electrode;
a diffusion plate to diffuse the light from the flat fluorescent lamp, the diffusion plate being disposed on the flat fluorescent lamp;
at least one optical sheet disposed on the diffusion plate; and
a second mold to fix the diffusion plate and the optical sheet to the receiving container.

24. A liquid crystal display apparatus comprising:
a receiving container having a receiving space;
a flat fluorescent lamp having a lamp body divided into a plurality of discharge spaces to generate light and an external electrode that is formed at both ends of the lamp body and intersects with the discharge spaces, the flat fluorescent lamp being received into the receiving space;
a first mold to fix the flat fluorescent lamp to the receiving container and to cover the external electrode, the first mold having an auxiliary electrode electrically connected to the external electrode;
an inverter to generate a discharge voltage for the flat fluorescent lamp; and
a liquid crystal display panel to display an image using the light from the flat fluorescent lamp.

25. The liquid crystal display apparatus of claim 24, wherein the external electrode comprises:
a main electrode portion intersecting the discharge spaces; and
a first compensation electrode portion extending from the main electrode portion at the outermost discharge spaces among the discharge spaces,
and wherein the auxiliary electrode is formed at the outermost discharge spaces where the first compensation electrode portion is formed.

26. The liquid crystal display apparatus of claim 25, wherein the external electrode further comprises a second compensation electrode portion extending from the main electrode portion at a center discharge space among the discharge spaces, and wherein the auxiliary electrode is formed at the discharge spaces where the first and second compensation electrodes are formed.
